(19) United States
(12) Patent Application Publication
(10) Pub. No.: US 2026/0103941 A1
(43) Pub. Date: Apr. 16, 2026

(54) FENESTRATION UNIT MOUNTING BRACKETS AND ASSOCIATED METHODS

(71) Applicant: Pella Corporation, Pella, IA (US)

(72) Inventors: Todd A. Bernhagen, Pella, IA (US); Jake Baier, Pella, IA (US); Jaime Ogbourne, Pella, IA (US)

(73) Assignee: Pella Corporation, Pella, IA (US)

(21) Appl. No.: 19/355,521

(22) Filed: Oct. 10, 2025

Related U.S. Application Data
(60) Provisional application No. 63/707,999, filed on Oct. 16, 2024.

(51) Int. Cl. E06B 1/60

(52) U.S. Cl. CPC E06B 1/6015

(57) ABSTRACT

A fenestration unit is configured for installation in a rough opening in a structure defined by rough opening framing. The fenestration unit includes a frame including a channel and a first mounting bracket. The first mounting bracket includes a first leg and an interlocking cam coupled to the first leg. The interlocking cam is configured to be received in the channel of the frame, and the interlocking cam is pivotable from an unlocked configuration to a locked configuration. In the unlocked configuration, the interlocking cam permits detachment of the first mounting bracket from the frame, and in the locked configuration the interlocking cam secures the first mounting bracket to the frame. The first mounting bracket further includes a second leg coupled to the first leg. The second leg is angularly offset from the first leg and is configured to abut an interior face of the rough opening framing.

### CROSS-REFERENCE TO RELATED APPLICATION

This application claims priority to U.S. Provisional Patent Application No. 63/707,999, entitled “FENESTRATION UNIT MOUNTING BRACKETS AND ASSOCIATED METHODS”, filed Oct. 16, 2024, the disclosure of which is hereby incorporated by reference in its entirety.

### BACKGROUND

Sliding patio doors typically have an exterior nailing flange and are installed from the exterior side of a rough opening of a building. Two or more installers work together on the interior and the exterior of the building to install the sliding patio door into the rough opening. In this process, the installers may need to support at least part of the weight of the sliding patio door to stabilize it within the rough opening framing of the building during installation steps.

Background Patents

| Patent Number | Title | Filing Date |
|---|---|---|
| U.S. Pat. No. 8,621,795 | Fenestration frame with bonded support | 2011 Apr. 20 |
| | brackets . . . | |
| U.S. Pat. No. 7,162,841 | Spring clip and method of window | 2004 Feb. 13 |
| | installation | |
| DE 2020 16101375 | Supporting and fastening | 2016 Mar. 11 |
| | window . . . to . . . wall opening | |
| WO 2015/142201 | Mounting, sealing and thermal insulation | 2014 Sep. 5 |
| | of windows . . . | |
| U.S. Pat. No. 6,293,061 | System and method for installing a jamb | 1999 Sep. 30 |
| U.S. Pat. No. 11,332,946 | Installation features for fenestration | 2019 Jul. 25 |
| | units . . . | |
| U.S. Pat. No. 8,006,445 | Self-sealing window installation and | 2008 Jan. 15 |
| | method | |
| U.S. 2008/0127564 | Pre-hung door assembly and method of | 2008 Jan. 18 |
| | installation | |
| U.S. Pat. No. 10,895,099 | Support bracket for window | 2016 Aug. 23 |
| | installation . . . | |
| U.S. Pat. No. 10,794,069 | Door Hanger Bracket | 2018 Sep. 21 |
| U.S. RE45,355 | Door Hanger | 2012 Nov. 19 |
| U.S. Pat. No. 11,933,098 | Fenestration Units with Interior | 2023 Sep. 29 |
| | Installation Features and Associated | |
| | Systems and Methods | |

### Background Products

### Innotech Windows & Doors, Strap Anchors

https://www.innotech-windows.com/blog/in-depth-benefits-of-anchoring-method-window-installation

### FrontLine Tru-Loc™ Brackets

https://frontlinebldg.com/all-products/accessories/tru-loc-window-door-installation-anchor/

### Amesbury Hinged Fin

https://www.amesburytruth.com/products/extrusions/nailing-fin/hinged/hinged-pp 1219

### EZ-Hang™ Brackets

https://ezhangdoor.com/

### SUMMARY

The fenestration unit includes a mounting system that may be used to hold and stabilize the fenestration unit within a rough opening framing during installation of the fenestration unit. In some examples, the mounting system may be easily coupled to the frame of the fenestration unit immediately before installing the unit in the rough opening. The mounting system may provide a means to accurately gauge against the rough opening framing during installation of the fenestration unit.

According to one embodiment (“Embodiment 1”), a fenestration unit is configured for installation in a rough opening in a structure defined by rough opening framing, the rough opening framing having an interior face and an exterior face opposite the interior face. The fenestration unit includes a frame including a channel and a first mounting bracket. The first mounting bracket includes a first leg and an interlocking cam coupled to the first leg. The interlocking cam is configured to be received in the channel of the frame, and the interlocking cam is pivotable from an unlocked configuration to a locked configuration. In the unlocked configuration, the interlocking cam permits detachment of the first mounting bracket from the frame, and in the locked configuration the interlocking cam secures the first mounting bracket to the frame. The first mounting bracket further includes a second leg coupled to the first leg. The second leg is angularly offset from the first leg and is configured to abut the interior face of the rough opening framing.

According to another embodiment (“Embodiment 2”), the fenestration unit of Embodiment 1, wherein the channel includes a sidewall and an undercut portion, the interlocking cam includes a foot. In the locked configuration, the foot is disposed in the undercut portion and behind the sidewall of the channel, and in the unlocked configuration the foot is disposed apart from the sidewall of the channel.

According to one embodiment (“Embodiment 3”), the fenestration unit of Embodiment 2, wherein the interlocking cam further includes a central waist coupled to the foot.

According to another embodiment (“Embodiment 4”), the fenestration unit of any of Embodiments 1-3, wherein the interlocking cam includes an aperture configured to receive a tool for pivoting the interlocking cam.

According to one embodiment (“Embodiment 5”), the fenestration unit of any of Embodiments 1-4, wherein the first leg further includes a claw.

According to another embodiment (“Embodiment 6”), the fenestration unit of Embodiment 5, wherein the channel is a first channel, the frame further includes a second channel disposed on the perimeter, and the claw is configured to be removably received in the second channel to secure the first mounting bracket to the frame.

According to one embodiment (“Embodiment 7”), the fenestration unit of any of Embodiments 5-6, wherein the claw includes an ankle portion and a toe portion coupled to the ankle portion.

According to another embodiment (“Embodiment 8”), the fenestration unit of any of Embodiments 5-7, wherein the first leg defines a longitudinal axis of the bracket, and the claw is disposed longitudinally between the interlocking cam and the second leg.

According to one embodiment (“Embodiment 9”), the fenestration unit of any of Embodiments 5-7, wherein the first leg defines a longitudinal axis of the bracket, and the second leg is disposed longitudinally between the interlocking cam and the claw.

According to another embodiment (“Embodiment 10”), the fenestration unit of any of Embodiments 1-9, wherein the first leg is integrally formed with the second leg

According to one embodiment (“Embodiment 11”), the fenestration unit of any of Embodiments 1-10, wherein the second leg includes an aperture configured to receive a fastener for securing the fenestration unit to the rough opening framing.

According to another embodiment (“Embodiment 12”), the fenestration unit of any of Embodiments 1-11, wherein the frame further includes an exterior surface, an interior surface opposite the exterior surface, and a perimeter between the exterior surface and the interior surface, the channel is disposed on the perimeter.

According to one embodiment (“Embodiment 13”), a method of installing a fenestration unit in a rough opening in a structure defined by rough opening framing, the rough opening framing having an interior face and an exterior face opposite the interior face, includes: coupling a first mounting bracket to a frame of the fenestration unit by positioning an interlocking cam coupled to a first leg of the first mounting bracket in a channel of the frame, and pivoting the interlocking cam from an unlocked configuration to a locked configuration; seating the fenestration unit in the rough opening by together translating the frame and the first mounting bracket in an exterior direction within the rough opening until a second leg of the first mounting bracket angularly offset from the first leg is abutted against the interior face of the rough opening framing; and securing the fenestration unit to the rough opening framing.

According to another embodiment (“Embodiment 14”), the method of Embodiment 13, wherein the channel includes a sidewall and an undercut portion, the interlocking cam includes a foot, in the unlocked configuration the foot is disposed apart from the sidewall of the channel, and in the locked configuration the foot is disposed in the undercut portion and behind the sidewall of the channel.

According to one embodiment (“Embodiment 15”), the method of any of Embodiments 13-14, wherein the interlocking cam includes an aperture, and pivoting the interlocking cam from the unlocked configuration to the locked configuration includes inserting a tool into the aperture and pivoting the interlocking cam using the tool.

According to another embodiment (“Embodiment 16”), the method of any of Embodiments 13-15, wherein the first leg further includes a claw.

According to one embodiment (“Embodiment 17”), the method of Embodiment 16, wherein the channel is a first channel, the frame further includes a second channel disposed on the perimeter, and coupling the first mounting bracket to the frame further includes removably positioning the claw in the second channel.

According to another embodiment (“Embodiment 18”), the method of any of Embodiments 16-17, wherein the claw includes an ankle portion and a toe portion coupled to the ankle portion, and removably positioning the claw in the second channel includes removably positioning the toe portion in the second channel.

According to one embodiment (“Embodiment 19”), the method of any of Embodiments 16-18, wherein the first leg defines a longitudinal axis of the bracket, and the claw is disposed longitudinally between the interlocking cam and the second leg.

According to another embodiment (“Embodiment 20”), the method of Embodiments 16-18, wherein the first leg defines a longitudinal axis of the bracket, and the second leg is disposed longitudinally between the interlocking cam and the claw.

According to one embodiment (“Embodiment 21”), the method of any of Embodiments 13-20, wherein the first leg is integrally formed with the second leg.

According to another embodiment (“Embodiment 22”), the method of any of Embodiments 13-21, wherein the second leg includes an aperture, and securing the fenestration unit to the rough opening framing includes inserting a fastener in the aperture.

According to one embodiment (“Embodiment 23”), the method of any of Embodiments 13-22, wherein the frame further includes an exterior surface, an interior surface opposite the exterior surface, and a perimeter between the exterior surface and the interior surface, the channel is disposed on the perimeter.

The foregoing embodiments and additional embodiments described herein should not be read to limit or otherwise narrow the scope of any of the inventive concepts otherwise provided by the instant disclosure. While multiple examples are disclosed, still other embodiments will become apparent to those skilled in the art from this specification and its drawings, which show and describe various illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description, serve to explain the principles of the disclosure.

FIG. 1 is a top-oriented perspective view of a sliding fenestration unit from an interior side of a building structure showing a mounting system in an installation configuration, according to some embodiments.

FIG. 2 is a top-oriented perspective view of the sliding fenestration unit of FIG. 1 from the exterior side of a building structure showing the mounting system in the installation configuration, according to some embodiments.

FIG. 3 is a side-oriented enlarged view of portions of the mounting system and a frame of the sliding fenestration unit of FIG. 1, according to some embodiments.

FIG. 4 is a side-oriented sectional view of a mounting bracket of the mounting system and the frame of FIG. 3, according to some embodiments; the mounting bracket is illustrated in a locked configuration.

FIG. 5 is a side-oriented sectional view of a mounting bracket of the mounting system and the frame of FIG. 3, according to some embodiments; the mounting bracket is illustrated in an unlocked configuration.

FIG. 6 is a top-oriented perspective view of the mounting bracket of FIG. 3, according to some embodiments.

FIG. 7 is a bottom-oriented perspective view of the mounting bracket of FIG. 3, according to some embodiments.

FIG. 8 is a top-oriented perspective view of an interlocking cam of the mounting bracket of FIGS. 6 and 7, according to some embodiments.

FIG. 9 is a side-oriented view of the interlocking cam of FIG. 8, according to some embodiments.

FIG. 10 is a front-oriented view of the interlocking cam of FIG. 8, according to some embodiments.

FIG. 11 is a bottom-oriented view of the interlocking cam of FIG. 8, according to some embodiments.

FIG. 12 is a top-oriented perspective view of another mounting bracket for a sliding fenestration unit, according to some embodiments.

FIG. 13 is a bottom-oriented perspective view of the mounting bracket of FIG. 12, according to some embodiments.

FIG. 14 is a front-oriented perspective view of another interlocking cam for a sliding fenestration unit, according to some embodiments.

FIG. 15 is a top-oriented perspective view of the interlocking cam of FIG. 14, according to some embodiments.

FIG. 16 is a top-oriented perspective view of another interlocking cam for a sliding fenestration unit, according to some embodiments.

FIG. 17 is a side-oriented view of the interlocking cam of FIG. 16, according to some embodiments.

FIG. 18 is a front-oriented view of the interlocking cam of FIG. 16, according to some embodiments.

FIG. 19 is a bottom-oriented view of the interlocking cam of FIG. 16, according to some embodiments.

FIG. 20 is a top-oriented perspective view of yet another interlocking cam for a sliding fenestration unit, according to some embodiments.

FIG. 21 is a side-oriented view of the interlocking cam of FIG. 20, according to some embodiments.

FIG. 22 is a front-oriented view of the interlocking cam of FIG. 20, according to some embodiments.

FIG. 23 is a bottom-oriented view of the interlocking cam of FIG. 20, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement may deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale and may be exaggerated to illustrate various aspects of the present disclosure, and in that regard, the drawing figures should not be construed as limiting.

### Description of Various Embodiments

Various concepts of this patent specification address installation systems and methods for fenestration units, such as windows and doors. Some features of such systems and methods include one or more of the following: the fenestration unit configured to be set into a rough opening (RO) from the interior side of a building structure or wall defined by a rough opening framing; gauging to the interior face of a rough opening framing for more accurate finishing (for example, drywall and/or trim offsets); and the fenestration unit being configured to be installed by a single person/installer or fewer installers than traditional installation setups. In some examples, based at least in part on a weight of the fenestration unit, installation may require more than one installer, such as two installers, to complete traditional installation steps. In other examples where the fenestration unit is relatively light (for example, a knock-down door), traditional installation steps may be completed by a single installer. The installation time and labor costs may be decreased for installation of the fenestration unit described herein as compared to traditional installation steps.

In various examples, the fenestration units (for example, fenestration unit 100) include features that promote installation of the fenestration unit from an interior side of a rough opening (RO). In particular, a fenestration unit according to various examples includes an engagement system coupled to the frame, the engagement system configured to positively engage the interior face of the rough opening framing upon insertion of the fenestration unit in the rough opening (RO) from the interior side of the rough opening (RO). In this manner, one or more individuals may insert a fenestration unit into the rough opening (RO) on the interior side thereof and secure the fenestration unit to the interior side of the rough opening framing without needing another installer to hold the fenestration unit against the rough opening framing from an exterior side thereof. The engagement system, also referred to herein as a mounting bracket system or an anchoring clip system, may hold and stabilize the fenestration unit within a framing of the rough opening (RO) such that shims are not required to hold the fenestration unit in place.

In various embodiments, the fenestration unit is anchored to and stabilized against an interior side of the rough opening framing via the mounting bracket system. Mounting to the exterior side of the rough opening framing is not required, and in some examples, is not possible. In some examples, the exterior side of the rough opening framing includes insulation (for example, a foam board), which is relatively soft, and does not provide a solid surface to anchor against, or to drive fasteners therethrough. By providing a mounting bracket system that interfaces with the interior side of the framing, challenges due to exterior insulation may be lessened.

### Fenestration Units

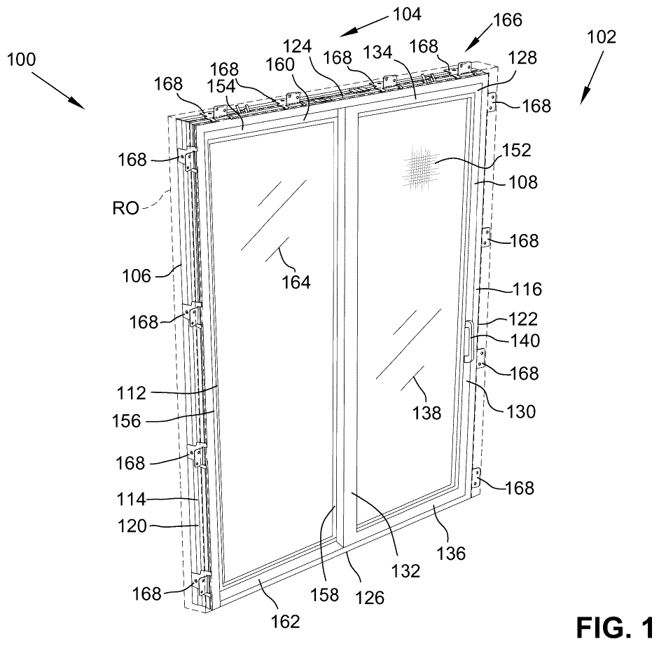

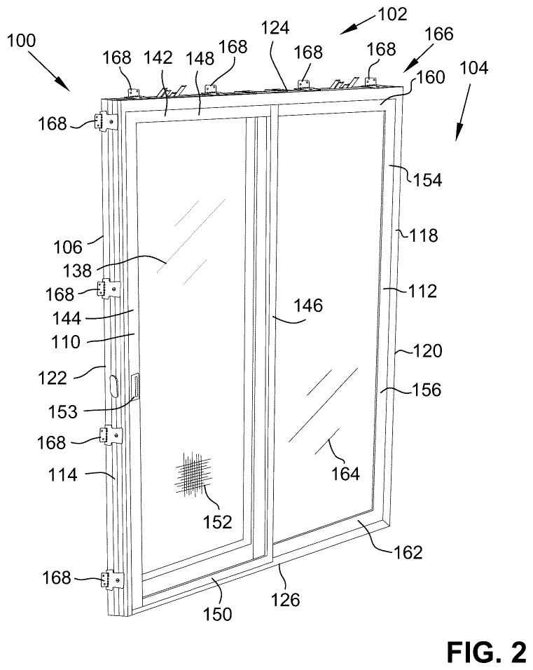

FIGS. 1 and 2 illustrate a fenestration unit 100 for installation in a rough opening (RO; FIG. 1) of a building structure, according to some embodiments. FIG. 1 illustrates a top-oriented perspective view of the fenestration unit 100 from an interior side 102 (for example, as the fenestration unit 100 would appear from an interior of the building structure), and FIG. 2 illustrates the fenestration unit 100 from an exterior side 104 (for example, as the fenestration unit 100 would appear from an exterior of the building structure). The fenestration unit 100 includes a frame 106, one or more sliding panels (illustratively, a first sliding panel 108 (FIG. 1) and a second sliding panel 110 (FIG. 2)), and one or more fixed panels (illustratively, one fixed panel 112). The fenestration unit 100 is depicted as a sliding door unit as an example, but it is understood that the term “fenestration unit” as used herein is to be read broadly and “fenestration unit” may also be implemented as sliding window units, fixed, double hung, hinged window or door units, or the like. In other examples, the fenestration unit 100 may be a multi-slide door, a bifold door, or another door without fixed and/or sliding panels.

The frame 106 may constructed of various appropriate materials, such as vinyl, fiberglass, wood, or the like. As shown, the frame 106 includes an outer perimeter 114 and has a front face 116, or interior surface (FIG. 1) facing the interior side 102, as well as a back face 118, or exterior surface (FIG. 2) facing the exterior side 104. The frame 106 is operable to be positioned in the rough opening (RO) of the building structure and supports the fixed panel 112, the first sliding panel 108, and the second sliding panel 110 therein. The frame 106 generally includes a first jamb 120, a second jamb 122, a frame head 124, and a lower rail 126 (for example, a sill).

Referring specifically to FIG. 1, the first sliding panel 108 is slidably positioned with the frame 106. The first sliding panel 108 has a sliding panel frame 128 including a first jamb 130, a second jamb 132, an upper rail 134 (for example, a head), and a lower rail 136 (for example, a sill). The first sliding panel 108 includes a glazing unit 138 supported by the sliding panel frame 128. The first jamb 130 of the first sliding panel 108 is positioned against the second jamb 122 of the frame 106 of the fenestration unit 100. The first jamb 130 of the first sliding panel 108 carries an interior handle 140 and an exterior handle (not shown), which can be actuated to slide the first sliding panel 108 between open and closed positions. The first sliding panel 108 may include locking components, such as a lock strike (not shown) for engaging and/or locking the first sliding panel 108 in the closed position. For example, the first sliding panel 108 may be engaged with the frame 106 of the fenestration unit 100 in the closed position when the locking components engage a corresponding structure on the frame 106, thereby limiting or inhibiting movement of the first sliding panel 108.

Referring specifically to FIG. 2, the second sliding panel 110 is slidably positioned with the frame 106. The second sliding panel 110 has a sliding panel frame 142 including a first jamb 144, a second jamb 146, an upper rail 148 (for example, a head), and a lower rail 150 (for example, a sill). The second sliding panel 110 includes a screen 152 supported by the sliding panel frame 142. The first jamb 144 of the second sliding panel 110 is positioned against the second jamb 122 of the frame 106 of the fenestration unit 100. The first jamb 144 of the second sliding panel 110 carries an exterior handle 153 and an interior handle (not shown), which can be actuated to slide the second sliding panel 110 between open and closed positions. The second sliding panel 110 may include locking components, such as a lock strike (not shown) for engaging and/or locking the second sliding panel 110 in the closed position. For example, the second sliding panel 110 may be engaged with the frame 106 of the fenestration unit 100 in the closed position when the locking components engage a corresponding structure on the frame 106, thereby limiting or inhibiting movement of the second sliding panel 110.

As shown in FIGS. 1 and 2, the fixed panel 112 is fixedly positioned with the frame 106. The fixed panel 112 includes a fixed panel frame 154 including a first jamb 156, a second jamb 158, an upper rail or head 160, and a lower rail 162. The fixed panel 112 includes a glazing unit 164 supported by the fixed panel frame 154. The first jamb 156 of the fixed panel 112 is positioned against the first jamb 120 of the frame 106.

Although the first sliding panel 108 and the fixed panel 112 may include glazing units 138, 164 as described, in various examples the first sliding panel 108 and/or the fixed panel 112 may alternatively include screens or opaque, solid, or filled panel designs that are not transparent (for example, wood, tile, fiberglass, vinyl, or other central paneling). Similarly, although the second sliding panel 110 may include the screen 152 as described, in various examples the second sliding panel 110 may alternatively include glazing or opaque, solid, or filled panel designs that are not transparent (for example, wood, tile, fiberglass, vinyl, or other central paneling).

Although the above examples have been discussed relating to fenestration units with both sliding panels and fixed panels, it is understood that the concepts and features discussed herein may be implemented in a variety of fenestration systems, including fixed panel units, hinged units, and so forth.

Referring now to FIGS. 1-3, the fenestration unit 100 further includes a mounting system 166, also described as an engagement system, that facilitates mounting the unit 100 in the rough opening. Although not specifically illustrated, the mounting system 166 may be initially detached and separate from the frame 106 (for example, during shipping to an installer), and FIGS. 1-3 illustrate the mounting system 166 coupled to the frame 106 in an installation configuration (that is, ready for installation in the rough opening). In certain examples, the fenestration unit 100 includes one or more additional systems that facilitate mounting the unit 100 in the rough opening, such as any of the installation stabilizer systems, weather seal systems, and/or shim guide systems described in U.S. Provisional Patent Application No. 63/684,018, entitled FENESTRATION UNIT WITH INSTALLATION FEATURES AND ASSOCIATED METHODS and filed Aug. 16, 2024, the disclosure of which is hereby incorporated by reference in its entirety.

The mounting system 166 includes a plurality of mounting brackets 168 coupled to the outer perimeter 114 of the frame 106. In particular, the mounting brackets 168 are coupled to the frame head 124, the first jamb 120, and the second jamb 122 (for example, at least four mounting brackets 168 are coupled to each). As illustrated, the mounting system 166 includes twelve (12) mounting brackets 168, although greater (for example, 14, 16, 18, etc.) or fewer (for example, 6, 8, 10, etc.) mounting brackets 168 may be used. As the dimensions of the fenestration unit 100 increase, more mounting brackets 168 may be warranted to ensure proper anchoring and support of the fenestration unit 100.

In certain examples, the mounting brackets 168 can facilitate gauging the fenestration unit 100 from an interior face of the rough opening. This gauging capability provides a proper offset for drywall thickness or other wall features and may reduce issues such as jamb extensions of the fenestration unit 100 being “proud” or “recessed” from an interior face of the finished wall surface (for example, at an inner face). The resulting installation using the mounting brackets 168 may facilitate providing flush jamb extensions relative to the interior face of the wall, which makes the installation of trim (for example, casing) of the fenestration unit 100 much more efficient for subsequent detailing steps (for example, finish carpenters).

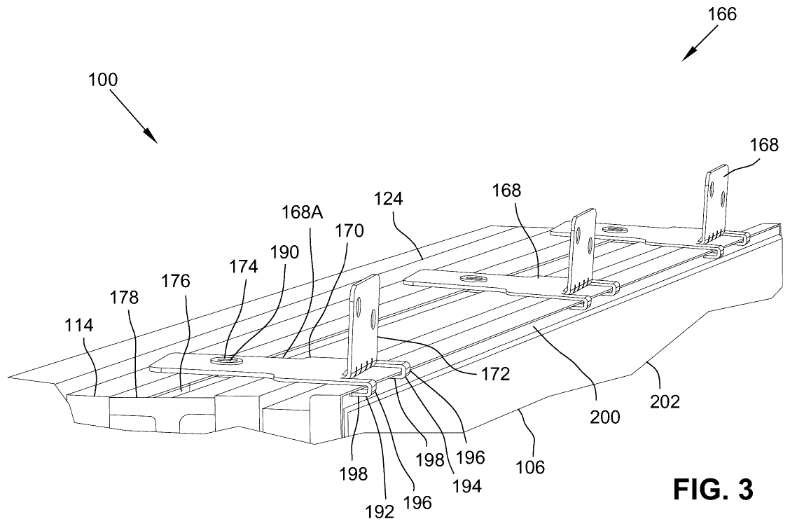

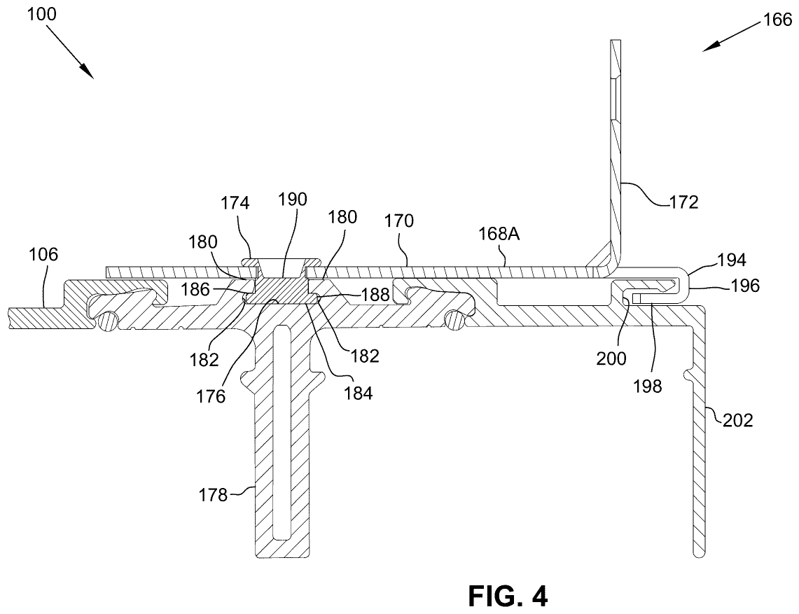

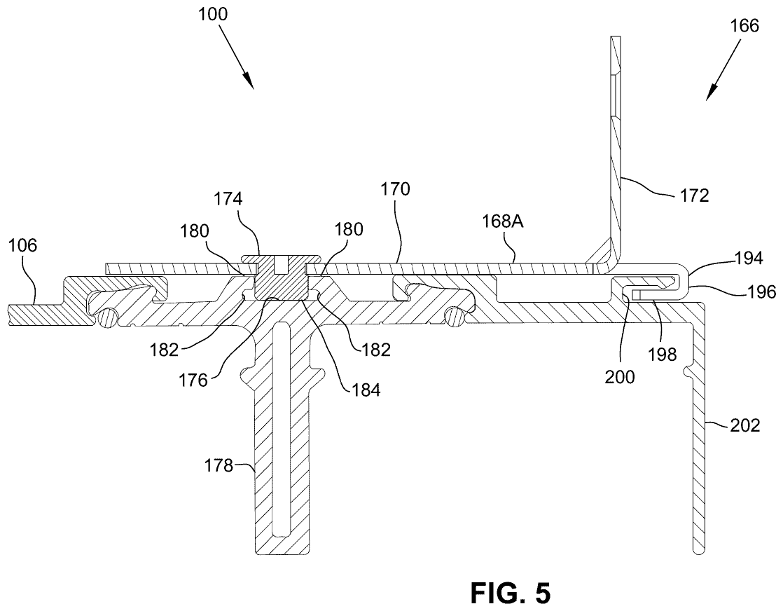

Referring now to FIGS. 3-5, the mounting brackets 168 may each be substantially similar to one another and are described cumulatively in association with a first mounting bracket 168A of the mounting brackets 168. The first mounting bracket 168A generally includes a first leg 170 configured to be disposed adjacent the frame 106, a second leg 172 that is angularly offset from the first leg 170 (for example, by about 90 degrees) and configured to abut the interior face of the rough opening framing (shown elsewhere), and an interlocking cam 174 coupled to the first leg 170. The interlocking cam 174 is configured to be received in a perimeter channel 176 of the frame 106 and selectively secures the mounting bracket 168A to the frame 106. More specifically, the interlocking cam 174 is pivotable relative to the first leg 170 and the frame 106 from an unlocked configuration (FIG. 5) to a locked configuration (FIG. 4). In the unlocked configuration, the interlocking cam 174 permits detachment of the first mounting bracket 168A from the frame 106, and in the locked configuration the interlocking cam 174 secures the first mounting bracket 168A to the frame 106. These aspects are described in further detail below.

As described briefly above, the interlocking cam 174 is configured to be received in the channel 176 of the frame 106. Illustratively, the channel 176 is formed in a thermal break 178 of the frame 106, which may be, for example, similar to or the same as any of the thermal breaks described in U.S. Provisional Patent Application No. 63/684,022, entitled FENESTRATION UNITS INCLUDING THERMAL BREAKS and filed Aug. 16, 2024, the disclosure of which is hereby incorporated by reference in its entirety. As shown in FIGS. 4 and 5, the channel 176 includes sidewalls 180 and undercut portions 182 (and, accordingly, the channel 176 may be referred to as a “T-slot”). In the locked configuration (FIG. 4), one or more feet of the interlocking cam 174, illustratively one foot 184 including a first toe portion 186 and an opposite, second toe portion 188, are disposed in the undercut portions 182 and behind the sidewalls 180 of the channel 176, thereby securing the first mounting bracket 168A to the frame 106. In the unlocked configuration (FIG. 5), the foot 184 of the cam 174 is disposed apart from the sidewalls 180 of the channel 176, or is disposed parallel to the longitudinal direction of the channel 176, thereby permitting detachment of the first mounting bracket 168A from the frame 106.

The interlocking cam 174 may be pivoted approximately 90 degrees between the unlocked configuration and the locked configuration. Such pivoting secures the cam 174, and thereby the mounting bracket 168, to the sidewalls 180 of the channel 176 and the frame 106. In certain examples, the interlocking cam 174 further includes an aperture 190 that faces away from the frame 106 and is configured to receive a tool (not shown) for pivoting the interlocking cam 174 between the unlocked configuration and the locked configuration. As specifically illustrated, the aperture 190 has an elongated shape for receiving, for example, a flat-head screwdriver. In other examples, the aperture 190 may have different shapes for receiving other types of tools, such as a Phillips-head screwdriver, a star-head screwdriver, an Allen wrench, or the like. In some examples, the cam 174 lacks an aperture and is shaped or otherwise configured to be pivoted by a different tool, such as a wrench or the like.

With continued reference to FIGS. 3-5, the first leg 170 of the mounting bracket 168A further includes one or more feet, illustratively a first claw 192 and a second claw 194 (FIG. 3), that also secure the mounting bracket 168A to the frame 106. Illustratively, each claw has a hook-like shape. More specifically, each claw includes an ankle portion 196 that extends transversely away from the first leg 170, a toe portion 198 that extends transversely away from the ankle portion 196 and toward the interlocking cam 174. The toe portion 198 is configured to be positioned in a second channel 200 of the frame 106 and thereby secures the mounting bracket 168A to the frame 106. Illustratively, the channel 200 is formed in an interior frame member 202 of the frame 106, which may be, for example, similar to or the same as any of the interior frame members described in U.S. Provisional Patent Application No. 63/684,022, previously incorporated by reference.

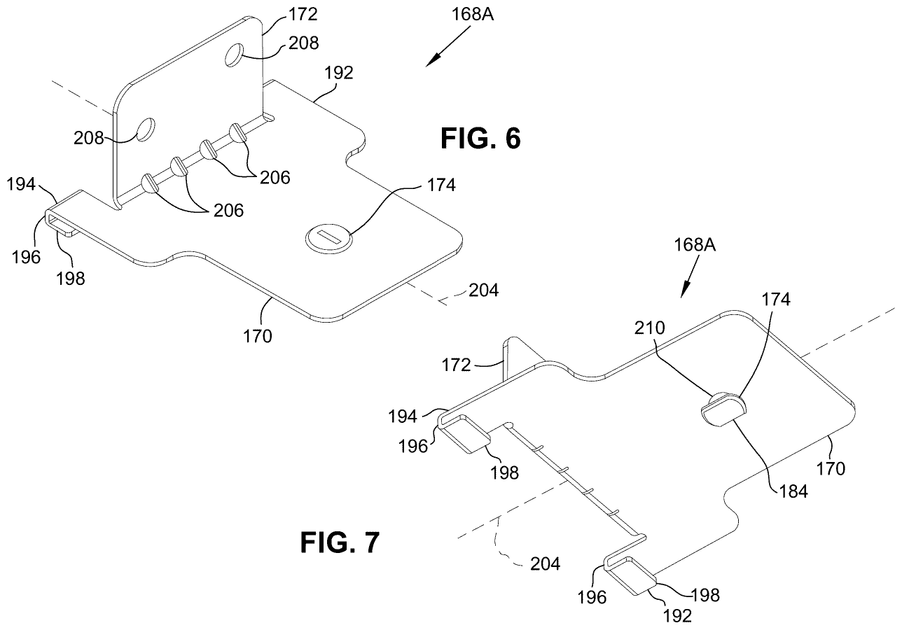

FIGS. 6 and 7 further illustrate the mounting bracket 168A. In certain examples, the first leg 170 defines a longitudinal axis 204 of the mounting bracket 168A, and the second leg 172 extends substantially perpendicularly away from the longitudinal axis 204 and the first leg 170. In other examples, the second leg 172 extends away from the longitudinal axis 204 and the first leg 170 at a different angle. In some examples, the second leg 172 is disposed longitudinally between the interlocking cam 174 and the first claw 192 and the second claw 194, particularly the ankle portions 196 and the toe portions of the feet 192, 194. In certain examples, the first claw 192 and the second claw 194 extend transversely away from the longitudinal axis 204 and in opposite directions from each other, and the feet 192, 194 are positioned on opposite sides of the second leg 172. In other examples, and as described in further detail below, the second leg 172 and the feet 192, 194 are arranged in different manners.

The first leg 170 may be integrally formed with the second leg 172. More specifically, one or more gussets 206 (for example, four gussets 206-FIG. 6) are integrally formed with the first leg 170 and the second leg 172 and reinforce the mounting bracket 168A. In other examples, the first leg 170 is not integrally formed with the second leg 172.

Illustratively, the second leg 172 comprises one or more apertures 208 (for example, two apertures 208-FIG. 6) that are each configured to receive a fastener (not shown) for securing the mounting bracket 168A, and thereby the fenestration unit 100, to the rough opening framing. In other examples, the second leg 172 lacks any apertures for receiving fasteners. In such examples, the mounting bracket 168A facilitates gauging the fenestration unit 100 from the interior face of the rough opening, and the fenestration unit 100 is secured to the rough opening frame in another manner.

With continued reference to FIGS. 6 and 7, the first leg 170 includes an aperture 210 (FIG. 7) through which the cam 174 extends. In some examples, the cam 174 is removably positioned in the aperture 210 and thereby removably coupled to the mounting bracket 168A. In other examples, the cam 174 is permanently positioned in the aperture 210 and thereby permanently coupled to the mounting bracket 168A. In some examples, the cam 174 is a monolithic component that is coupled to the mounting bracket 168A via pressing or swaging, a multiple component structure that is swaged together, or the cam 174 is coupled to the mounting bracket 168A via one or more retainers. Various examples are described in further detail below.

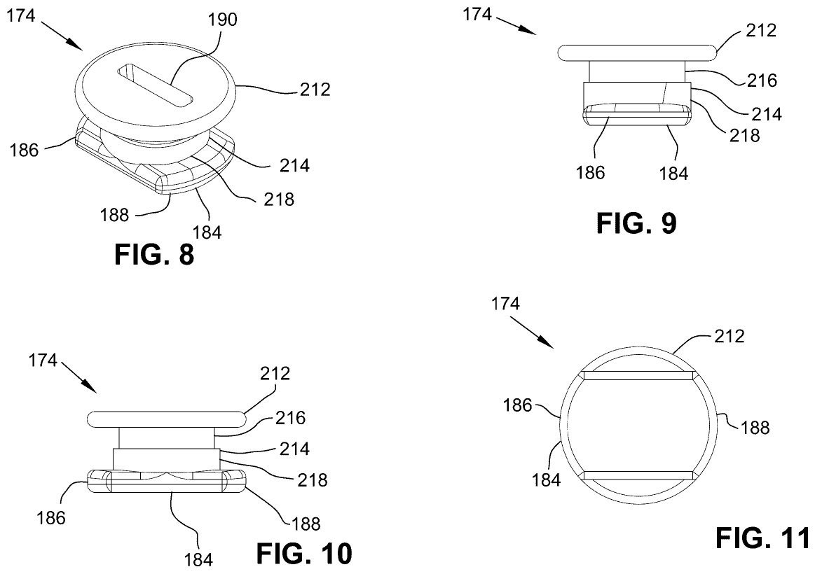

FIGS. 8-11 further illustrate the interlocking cam 174. The interlocking cam 174 includes a head 212 having the aperture 190 (FIG. 8) for receiving an installation tool, as described above. Illustratively, the head 212 is relatively large compared to the aperture 210 of the mounting bracket 168A (shown elsewhere) to inhibit detachment of the cam 174 from the mounting bracket 168A. In certain examples and as illustrated, the head 212 has a generally circular or disk-like shape. In other examples, the head 212 has a different shape (for example, hexagonal), for example, to facilitate being pivoted by a tool, such as a wrench or the like, as described above. In some examples, the head 212 includes one or more features that facilitate being pivoted by hand, such as a lever, knurling, or another type of grip.

The interlocking cam 174 further includes a central waist 214 that couples the head 212 to the foot 184. In some examples, the central waist 214 includes a first, relatively small portion 216 and a second, relatively wide portion 218. The first portion 216 is relatively small compared to and extends through the aperture 210 of the mounting bracket 168A (shown elsewhere). The second portion 218 is relatively large compared to the aperture 210 of the mounting bracket 168A to inhibit detachment of the cam 174 from the mounting bracket 168A. Stated another way, the second portion 218 of the central waist 214 and the head 212 of the cam 174 sandwich a portion of the first leg 170 of the mounting bracket 168A therebetween. In other examples, the central waist 214 may have other arrangements.

With continued reference to FIGS. 8-11, the foot 184 couples to the central waist 214 opposite the head 212. As described above, the foot 184 includes the first toe portion 186 and the opposite second toe portion 188. Illustratively, the toe portions 186, 188 provide the foot 184 with a flattened circular shape, as viewed from below (that is, as shown in FIG. 11). In other examples, the foot 184 may have a different shape.

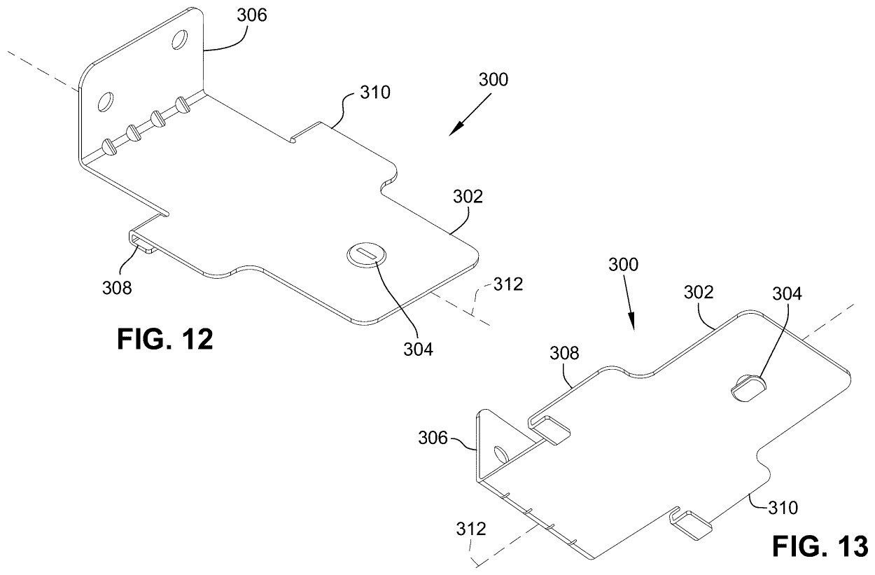

FIGS. 12 and 13 illustrate another mounting bracket 300, according to some examples. A plurality of the mounting brackets 300 may be coupled to the frame 106 of the fenestration unit 100, instead of the mounting brackets 168, to facilitate coupling the unit 100 to the rough opening framing. The mounting bracket 300 is similar to the mounting bracket 168A. More specifically, the mounting bracket 300 generally includes a first leg 302, an interlocking cam 304 coupled to the first leg 302 and pivotable from an unlocked configuration to a locked configuration, and a second leg 306 configured to abut the interior face of the rough opening framing. The interlocking cam 304 and the second leg 306 may be substantially similar to the interlocking cam 174 and the second leg 172 of the mounting bracket 168A, respectively. The first leg 302 is similar to the first leg 170 of the mounting bracket 168A. For example, the first leg 302 includes a first claw 308 and a second claw 310, which may be substantially similar to the first claw 192 and the second claw 194 of the mounting bracket 168A, respectively. However, the first leg 302 is elongated along the longitudinal axis 312 compared to the first leg 170 of the mounting bracket 168A. Relatedly, the first claw 308 and the second claw 310 are disposed longitudinally between the interlocking cam 304 and the second leg 306. Such a construction permits the mounting bracket 300 to gauge the fenestration unit 100 in a rough opening with a large wall thickness, for example a 2×6 construction, compared to a rough opening with a small wall thickness for the mounting bracket 168A, for example a 2×4 construction.

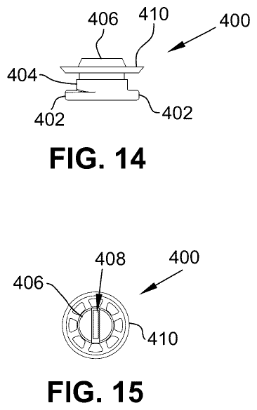

FIGS. 14 and 15 illustrate another interlocking cam 400, according to some examples. The cam 400 may be coupled to one or more mounting brackets 168 or one or more mounting brackets 300, instead of the cam 174 or the cam 304, respectively (shown elsewhere). The cam 400 may include substantially similar features as the cam 174, such as one or more feet 402, a waist portion 404, a head 406, and/or an aperture 408. The cam 400 further includes a retainer 410 positioned about the waist portion 404. The retainer 410 presses against the surface of a mounting bracket and thereby facilitates securing the cam 400 to the mounting bracket and inhibits inadvertent removal of the cam 400. The retainer 410 may include an external retaining ring that is applied onto to the cam 400 by pushing the external retaining ring onto the cam 400. In some examples, the retainer 410 may be applied when the cam 400 is in the locked configuration and may inhibit inadvertent pivoting to the unlocked configuration. When the cam 400 is in the locked configuration, the retainer 410 acts to force the feet 402 of the cam 400 against the walls of the frame 106 (shown elsewhere). This creates a both a frictional engagement and a mechanical interlock between the feet 402 and the walls of the frame 106 to inhibit inadvertent rotation of the cam 400 and inadvertent loosening of the cam 400 engagement with the mounting bracket.

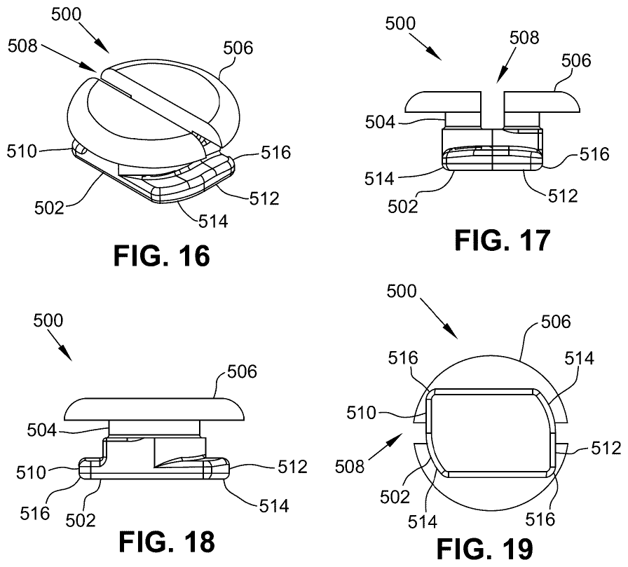

FIGS. 16-19 illustrate another interlocking cam 500, according to some examples. The cam 500 may be coupled to one or more mounting brackets 168 or one or more mounting brackets 300, instead of the cam 174, the cam 304, or the cam 400, respectively (shown elsewhere). The cam 500 may include substantially similar features as the cam 174, such as a foot 502, a waist portion 504 (FIGS. 17 and 18), a head 506, and/or an aperture 508 (FIGS. 16, 17, and 19). The foot 502 includes asymmetric first and second toe portions 510, 512. More specifically, each toe portion 510, 512 includes a rounded corner 514 and a flattened corner 516, and the flattened corners 516 contact the mounting bracket 168 to limit the range of pivoting movement of the cam 500 relative to the bracket 168, for example, to about 90 degrees. The cam 500 may be a monolithic component that is coupled to the mounting bracket 168A via pressing or swaging.

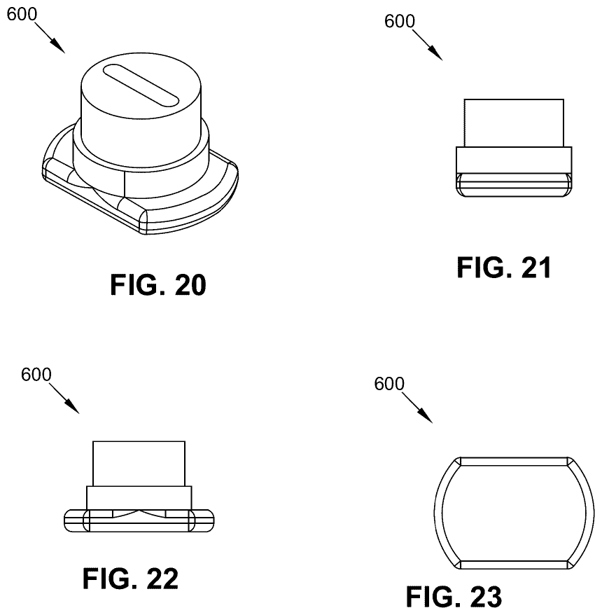

FIGS. 20-23 illustrate another interlocking cam 600, according to some examples. The cam 600 may be pressed or swaged to couple to the mounting bracket 168 and form the cam 174 (FIGS. 8-11). More specifically, the cam 600 may be deformed to form the cam 174 with the head 212.

### Fenestration Unit Installation Methods

Installation of the fenestration unit 100 can proceed in view of the various concepts described in the foregoing sections. Although the following description of installation of the fenestration unit 100 refers to the mounting brackets 168, it is understood that the other mounting brackets contemplated herein, such as the mounting brackets 300, may be used in a similar manner. Installation of the fenestration unit 100 in the rough opening (RO) may proceed from the interior side of the rough opening (RO) and may be executed by a single installer on the interior side of the rough opening (RO) where feasible, although multiple installers may be required (for example, where the unit 100 is particularly large and/or heavy).

As part of the installation process, the rough opening (RO) in the building structure is prepared for the fenestration unit 100 installation. Generally, the rough opening (RO) is sized to be between ½ inches and ¾ inches larger than the fenestration unit 100 in both width and height, although other setups may also be suitable. Some methods also include forming the rough opening (RO), such as by cutting out the rough opening (RO) (for example, plywood cladding covering rough opening framing). The lower rail portion of the framing of the rough opening framing (lower framing) may be flashed (for example, using appropriate flashing tape).

The fenestration unit 100 is then configured to the installation configuration. In particular, the mounting brackets 168, which may be initially separated from the frame 106, are coupled to the frame 106. More specifically, the feet 192, 194 of the mounting bracket 168A may first be positioned in the second channel 200 of the frame 106, and the mounting bracket 168 may then be pivoted such that the interlocking cams 174, in their unlocked configurations, enter the perimeter channel 176 of the frame 106. The cams 174 may then be pivoted relative to the first legs 170 of the brackets 168 and the frame 106 to reconfigure to their locked configurations. In some examples, once the mounting brackets 168 are secured to the frame 106, one or more of the mounting brackets 168 may be slid laterally along the perimeter channel 176 to a desired location on the frame 106. This facilitates quick re-adjustment of the position of the mounting brackets 168 along the frame 106 without needing to detach the mounting brackets 168 from the frame 106. In certain examples, the mounting brackets 168 may be manipulated and secured to the frame 106 by a single installer.

The fenestration unit 100 is then inserted or pushed into the rough opening (RO) from the interior side of the rough opening (RO), for example by a single installer or fewer installers than a traditional installation process. The ability and functionality to be installed from an interior side of the unit can be an important feature of the fenestration unit 100, as traditional fenestration installations require at least one installer on the exterior side of the rough opening (RO) and/or at least one installer on the interior side of the rough opening (RO). The fenestration unit 100 is pushed into the rough opening (RO) until the mounting brackets 168 engage the edges of the rough opening (RO), and specifically the jamb portions of the rough opening framing. The mounting brackets 168 are thereby configured to prevent the fenestration unit 100 from falling toward the exterior side of the rough opening (RO).

The fenestration unit 100 then may be centered in the rough opening (RO) and shimmed/leveled. The fenestration unit 100 may be centered side-to-side by inserting a screwdriver having a flat-blade/standard head (for example, ¼-inch-thick head) and rotating the screwdriver to ensure a minimum desired gap is achieved at the first jamb 120 and the second jamb 122. Once a desired levelling and spacing is achieved at the lower rail 126 of the fenestration unit 100, fasteners (for example, screws or nails) are driven through the mounting bracket 168 (for example, through the apertures 208) and into the rough opening framing. The fenestration unit 100 can then continue to be plumbed, squared, and fully coupled to the framing of the rough opening (RO). For example, an installer may plumb one of the first jamb 120 and the second jamb 122 to vertical level. Once plumbed to be vertically level, the remaining mounting brackets 168 are fastened to the rough opening framing such that the unit 100 is secured to the rough opening (RO).

The installer then may apply an air sealant (for example, spray foam or other air seal material) around the perimeter 114 of the fenestration unit 100, that is, in the gap between the rough opening (RO) framing and the fenestration unit 100, to create an interior air seal. This interior air seal may be continuous and substantially, or entirely, uninterrupted. An interior air seal typically is necessary for proper water management. This sealing operation is typically carried out from an interior side of the rough opening (RO).

In contrast to other methods and systems, at this point the fenestration unit 100 is entirely squared, plumbed, and securely fastened in the rough opening (RO) all from the interior side of the rough opening (RO). This can be accomplished by a single installer, rather than requiring two installers. At that time, or a later time as desired, the same installer, or another installer, may proceed to the exterior side of the rough opening (RO) to finish exterior water barrier installation for the fenestration unit 100 in the rough opening (RO). This is in contrast with traditional, nailing fin installations which require a second installer to be present on the exterior side of the rough opening (RO) during installation of the fenestration unit 100.

Various advantages may be achieved according to the foregoing example systems and methods. The various examples may be one or more of: more efficient (for example, cycle time reduced by 50% or more); easier to learn; easier to remember; easier to train; may be less physically demanding (for example, fenestration unit 100 is not set from the exterior side which could be on uneven ground or require a ladder); fenestration unit 100 is unable to fall out toward exterior during installation; can be installed by a single person from the interior of the building structure; interior and exterior installation tasks do not need to be done simultaneously; improved fenestration unit 100 install quality and fenestration unit 100 performance following installation; delivers an installation method that is unique to the industry and offers many benefits for the installer; faster cycle times; improved performance (water and air infiltration); adapts to wall depth variation; simplifies casing installation for finish carpenters; separates interior and exterior work so they can be done “independently”.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fenestration unit configured for installation in a rough opening in a structure defined by rough opening framing, the rough opening framing having an interior face and an exterior face opposite the interior face, the fenestration unit comprising:
a frame comprising a channel; and
a first mounting bracket including,
a first leg;
an interlocking cam coupled to the first leg and configured to be received in the channel of the frame, the interlocking cam being pivotable from an unlocked configuration to a locked configuration, in the unlocked configuration the interlocking cam permitting detachment of the first mounting bracket from the frame, and in the locked configuration the interlocking cam securing the first mounting bracket to the frame; and
a second leg coupled to the first leg, the second leg angularly offset from the first leg and configured to abut the interior face of the rough opening framing.

2. The fenestration unit of claim 1, wherein the channel comprises a sidewall and an undercut portion, the interlocking cam comprises a foot, in the locked configuration the foot being disposed in the undercut portion and behind the sidewall of the channel, and in the unlocked configuration the foot being disposed apart from the sidewall of the channel.

3. The fenestration unit of claim 2, wherein the interlocking cam further comprises a central waist coupled to the foot.

4. The fenestration unit of claim 1, wherein the interlocking cam comprises an aperture configured to receive a tool for pivoting the interlocking cam.

5. The fenestration unit of claim 1, wherein the first leg further comprises a claw.

6. The fenestration unit of claim 5, wherein the channel is a first channel, the frame further comprises a second channel disposed on the perimeter, and the claw is configured to be removably received in the second channel to secure the first mounting bracket to the frame.

7. The fenestration unit of claim 5, wherein the claw includes an ankle portion and a toe portion coupled to the ankle portion.

8. The fenestration unit of claim 5, wherein the first leg defines a longitudinal axis of the bracket, and the claw is disposed longitudinally between the interlocking cam and the second leg.

9. The fenestration unit of claim 5, wherein the first leg defines a longitudinal axis of the bracket, and the second leg is disposed longitudinally between the interlocking cam and the claw.

10. The fenestration unit of claim 1, wherein the first leg is integrally formed with the second leg.

11. The fenestration unit of claim 1, wherein the second leg comprises an aperture configured to receive a fastener for securing the fenestration unit to the rough opening framing.

12. The fenestration unit of claim 1, wherein the frame further comprises an exterior surface, an interior surface opposite the exterior surface, and a perimeter between the exterior surface and the interior surface, the channel being disposed on the perimeter.

13. A method of installing a fenestration unit in a rough opening in a structure defined by rough opening framing, the rough opening framing having an interior face and an exterior face opposite the interior face, the method comprising:
coupling a first mounting bracket to a frame of the fenestration unit by positioning an interlocking cam coupled to a first leg of the first mounting bracket in a channel of the frame, and pivoting the interlocking cam from an unlocked configuration to a locked configuration;
seating the fenestration unit in the rough opening by together translating the frame and the first mounting bracket in an exterior direction within the rough opening until a second leg of the first mounting bracket angularly offset from the first leg is abutted against the interior face of the rough opening framing; and
securing the fenestration unit to the rough opening framing.

14. The method of claim 13, wherein the channel comprises a sidewall and an undercut portion, the interlocking cam comprises a foot, in the unlocked configuration the foot being disposed apart from the sidewall of the channel, and in the locked configuration the foot being disposed in the undercut portion and behind the sidewall of the channel.

15. The method of claim 13, wherein the interlocking cam comprises an aperture, and pivoting the interlocking cam from the unlocked configuration to the locked configuration comprises inserting a tool into the aperture and pivoting the interlocking cam using the tool.

16. The method of claim 13, wherein the first leg further comprises a claw.

17. The method of claim 16, wherein the channel is a first channel, the frame further comprises a second channel disposed on the perimeter, and coupling the first mounting bracket to the frame further comprises removably positioning the claw in the second channel.

18. The method of claim 17, wherein the claw includes an ankle portion and a toe portion coupled to the ankle portion, and removably positioning the claw in the second channel comprises removably positioning the toe portion in the second channel.

19. The method of claim 16, wherein the first leg defines a longitudinal axis of the bracket, and the claw is disposed longitudinally between the interlocking cam and the second leg.

20. The method of claim 16, wherein the first leg defines a longitudinal axis of the bracket, and the second leg is disposed longitudinally between the interlocking cam and the claw.

21. The method of claim 13, wherein the first leg is integrally formed with the second leg.

22. The method of claim 13, wherein the second leg comprises an aperture, and securing the fenestration unit to the rough opening framing comprises inserting a fastener in the aperture.

23. The method of claim 13, wherein the frame further comprises an exterior surface, an interior surface opposite the exterior surface, and a perimeter between the exterior surface and the interior surface, the channel being disposed on the perimeter.
